(19) United States
(12) Patent Application Publication
(10) Pub. No.: US 2010/0012909 A1
(43) Pub. Date: Jan. 21, 2010

(54) LIFTING APPARATUS

(75) Inventor: Yeo (Joseph) B. Lee, Santa Clara, CA (US)

Correspondence Address: MAIER & MAIER, PLLC, 1000 DUKE STREET, ALEXANDRIA, VA, 22314, US

(73) Assignee: K&L Supply Co., Inc., Santa Clara, CA (US)

(21) Appl. No.: 12/486,374

(22) Filed: Jun. 17, 2009

Related U.S. Application Data
(60) Provisional application No. 61/129,796, filed on Jul. 17, 2008.

(51) Int. Cl. B66F 3/25

(52) U.S. Cl. 254/93 R

(57) ABSTRACT

A utility lift may include a base frame; a platform; a first support frame that may include a plurality of support arms, wherein the first support frame may extend between the base frame and the platform; a second support frame that may include a plurality of support arms, wherein the second support frame may extend between the base frame and the platform, wherein the second support frame may be rotatably coupled to the first support frame; a lifting power source assembly coupled to the base frame and the second support frame; and a pump that may be coupled to the base frame, wherein the pump may be coupled in flow communication to the lifting power source assembly using a fluid line.

### RELATED APPLICATIONS

This application claims priority, under 35 U.S.C. §119(e), to U.S. Provisional Patent Application Ser. No. 61/129,796, filed Jul. 17, 2008, the disclosure of which is incorporated by reference herein in its entirety.

### BACKGROUND

Hydraulic and/or air lifts, such as automobile lifts, are commonly used to enable a user to work on heavy equipment, such as automobiles, motorcycles, all-terrain vehicles and/or other personal transportation equipment. Some known examples of lifts may be permanently coupled to a floor and generally require a large dedicated space. Such examples may not be practical for individual enthusiasts that desire to work on their own equipment.

Other known examples of lifts merely lift one end of the object and/or only partially lift the object off the ground. Such examples make working on the object very difficult since the user is generally forced to work close to the ground or on their back underneath the object. As a result, a user wishing to work on their personal transportation equipment at a comfortable standing level may be forced to purchase a larger lift than they need and/or dedicate a large portion of the property to house the lift.

### SUMMARY

According to at least one embodiment, a utility lift may include a base frame; a platform; a first support frame that may include a plurality of support arms, wherein the first support frame may extend between the base frame and the platform; a second support frame that may include a plurality of support arms, wherein the second support frame may extend between the base frame and the platform, wherein the second support frame may be rotatably coupled to the first support frame; a lifting power source assembly coupled to the base frame and the second support frame; and a pump that may be coupled to the base frame, wherein the pump may be coupled in flow communication to the lifting power source assembly using a fluid line.

In an exemplary method of lifting a desired object, the method may include loading an object onto a platform supported by a first support frame, a second support frame and a base frame, wherein the first and second support frames may be rotatably coupled together using a pivot shaft; actuating a pump that may be coupled in fluid communication with a hydraulic cylinder; extending a piston that may be slidably coupled to the hydraulic cylinder; and increasing a height of the platform by rotating the second support frame about the pivot shaft with respect to the first support frame.

### BRIEF DESCRIPTION OF THE FIGURES

Advantages of embodiments of the utility lift will be apparent from the following detailed description of the exemplary embodiments thereof, which description should be considered in conjunction with the accompanying drawings in which:

FIG. 1 is a front perspective view of a lift assembly;

FIG. 2 is a side perspective view of the lift assembly shown in FIG. 1;

FIG. 3 is a partially exploded isometric view of the lift assembly shown in FIG. 1; and

FIG. 4 is an isometric view of the lift assembly shown in FIG. 1 including a plurality of attachments.

FIG. 5a is an isometric view of a locking mechanism in a lowered disengaged position.

FIG. 5b is an isometric view of a locking mechanism in a lowered engaged position.

FIG. 5c is an isometric view of a locking mechanism in a raised disengaged position.

### DETAILED DESCRIPTION

Aspects of the utility lift are disclosed in the following description and related drawings directed to specific embodiments of the utility lift. Alternate embodiments may be devised without departing from the spirit or the scope of the utility lift. Additionally, well-known elements of exemplary embodiments of the utility lift will not be described in detail or will be omitted so as not to obscure the relevant details of the utility lift. Further, to facilitate an understanding of the description a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the utility lift”, “embodiment” or “utility lift” do not require that all embodiments of the utility lift include the discussed feature, advantage or mode of operation.

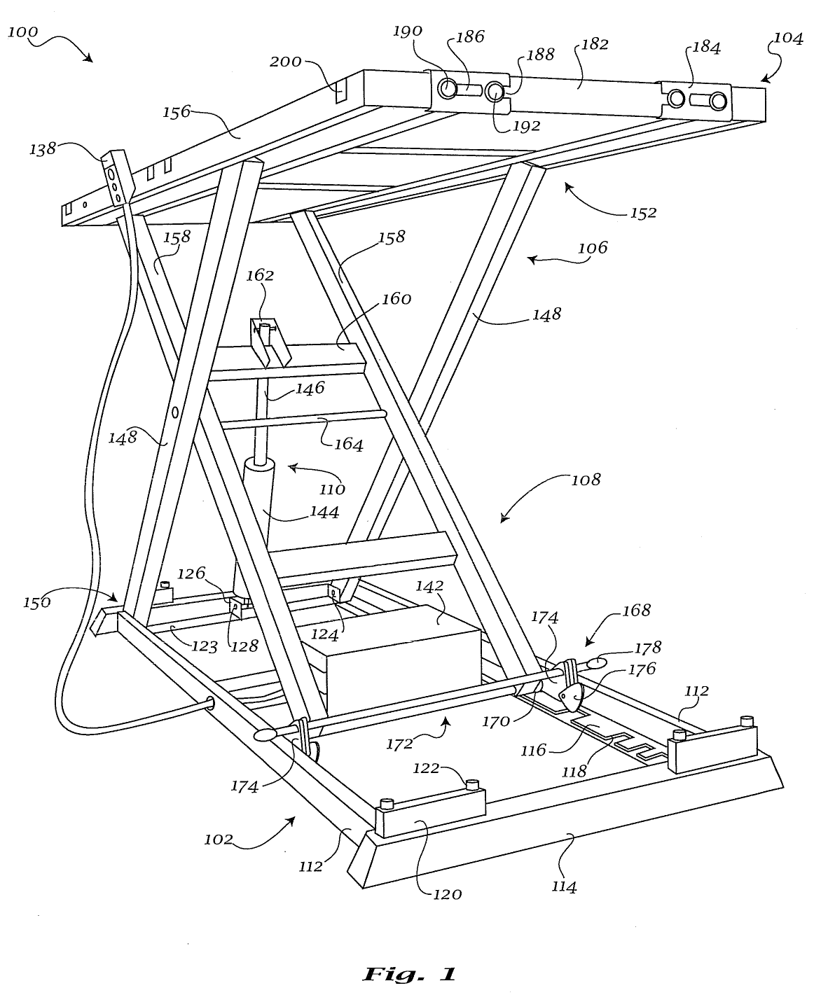

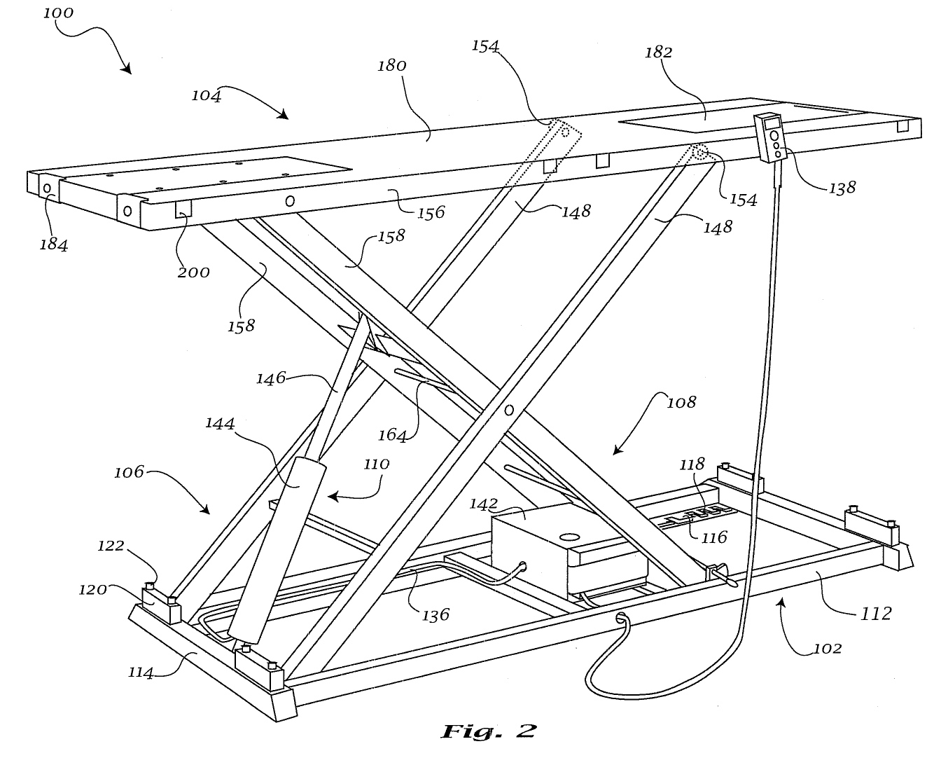

Referring to FIGS. 1-4, in the exemplary embodiment, lift assembly 100 may include a base frame 102, a lift platform 104, a first support frame 106 and a second support frame 108, wherein first and second support frames 106 and 108 may extend between base frame 102 and lift platform 104. First and second support frames 106 and 108 may be coupled together, wherein first support frame 106 may rotate with respect to second support frame 108, as described in more detail below. Lift assembly 100 may also include a lifting power source such as, but not limited to, a hydraulic cylinder 110 that may be coupled to base frame 102 and second support frame 108. In one embodiment, hydraulic cylinder 110 facilitates expanding lift assembly 100 from a compact, or loading position to an extended or expanded position, as shown in FIGS. 1 and 2.

Base frame 102 may include a pair of side-rails 112 that may be substantially parallel to one another. Moreover, base frame 102 may include a pair of end supports 114 that may be coupled to the pair of side-rails 112 such that end supports 114 may extend therebetween. As a result, base frame 102 may function as the foundation of lift assembly 100 and may have a substantially rectangular shape. Side-rails 112 and end supports 114 may be coupled together via welding, bolting, friction fixed or any other method of coupling known to one skilled in the art. In an alternative embodiment, base frame 102 may be formed in any other desired shape or configuration, for example, a substantially square shape. Moreover, each side-rail 112 may include an elevated portion 116 coupled thereto, wherein the elevated portion 116 may include a plurality of grooves, or notches 118 defined therein. Each side rail 112 may also include a base portion coupled thereto, wherein the base portion is disposed in a plane parallel to and below that of elevated portion 116. In one embodiment, notches 118 may facilitate locking second support frame 108 in a specific position, as described in more detail below.

In the exemplary embodiment, base frame 102 may include a plurality of foot stops 120 coupled to end supports 114 and extending away therefrom. In one embodiment, foot stops 120 may include an elastic bump 122 coupled thereto. Alternatively, elastic bumps 122 may be fabricated from rubber, silicone and/or any other elastic-type material known to a person having ordinary skill in the art that enables lift assembly 100 to function as described herein. In yet another embodiment, each foot stop 120 may be made from an elastic-type material such as, but not limited, to rubber, silicone and/or plastic. Alternatively, foot stop 120 may be made from any material known to a person having ordinary skill in the art that enables lift assembly 100 to function as described herein. In one embodiment, one of the end supports 114 may include a mounting bracket 123 coupled thereto. Moreover, mounting bracket 123 may include a pair of support frame mounting flanges 124 and a plurality of hydraulic cylinder mounting flanges 126. In the exemplary embodiment, flanges 124 and 126 may include apertures 128 defined therein. Mounting bracket 123 may facilitate coupling first support frame 106 and hydraulic cylinder 110 thereto, as described in more details below.

In the exemplary embodiment, base frame 102 may also include a pump device 130 that may facilitate operating hydraulic cylinder 110. In one embodiment, pump device 130 may include a motor 132 that may be operatively coupled to a tank 134 that may facilitate housing an amount of hydraulic fluid (not shown). In one embodiment, a hydraulic line 136 (shown in FIG. 2) may be coupled in flow communication to pump device 130 and hydraulic cylinder 110, wherein hydraulic line 136 facilitates channeling the hydraulic fluid either towards or away from hydraulic cylinder 110. In one embodiment, a remote control device 138 may be coupled to pump device 130, which enables the user to control pump device 130 and hydraulic cylinder 110. In the exemplary embodiment, pump device 130 may be coupled to base frame 102 such that pump device 130 may be positioned substantially between the pair of side-rails 112. For example, pump device 130 may be coupled to a pair of pump device support members 140 (shown in FIG. 2) that may extend between side-rails 112. In one embodiment, pump device 130 may include a cover 142 coupled to pump device support members 140 such that cover 142 facilitates covering pump device 130. In the exemplary embodiment, hydraulic cylinder assembly 110 may include a barrel portion 144 and a piston 146 that may be slidably coupled therein. In one embodiment, a first end of barrel 144 may be coupled to mounting bracket 123 using hydraulic cylinder mounting flanges 126 such that hydraulic cylinder assembly 110 may be pivotally coupled to base frame 102. As a result, hydraulic cylinder assembly 110 may pivot about mounting bracket 123. Moreover, in the example embodiment, piston 146 may have a distal end that may be pivotally coupled to second support frame 108, as described in more detail below.

During operation, hydraulic cylinder assembly 110 may be actuated using remote control device 138 such that the distal end of piston 146 may extend away from barrel 144. As a result, piston 146 may facilitate pushing second support frame 108 away from base frame 102, as described in more detail below. As such, hydraulic cylinder assembly 110 facilitates expanding lift assembly 100 from a compact position to an expanded position and vice versa.

As described above, lift assembly 100 may also include first support frame 106, as shown in FIGS. 1-3. In the exemplary embodiment, first support frame 106 may include a pair of support arms 148 that are substantially parallel to one another. Each support arm 148 may have a first end 150 and a second end 152. In one embodiment, first end 150 may be pivotally coupled to base frame 102 and more specifically mounting bracket 123. In the exemplary embodiment, first end 150 may include an aperture (not shown) defined therein that may extend through support arm 148. A pivot pin (not shown) may extend through support arm 148, base frame side-rail 112 and support frame mounting flange 124 to facilitate pivotally coupling support arm 148 to base frame 102 and to facilitate preventing lateral movement of support arms 148 with respect to base frame 102. As a result, the pair of support arms 148 may pivot about the pivot pin such that each support arm 148 may pivot with respect to base frame 102.

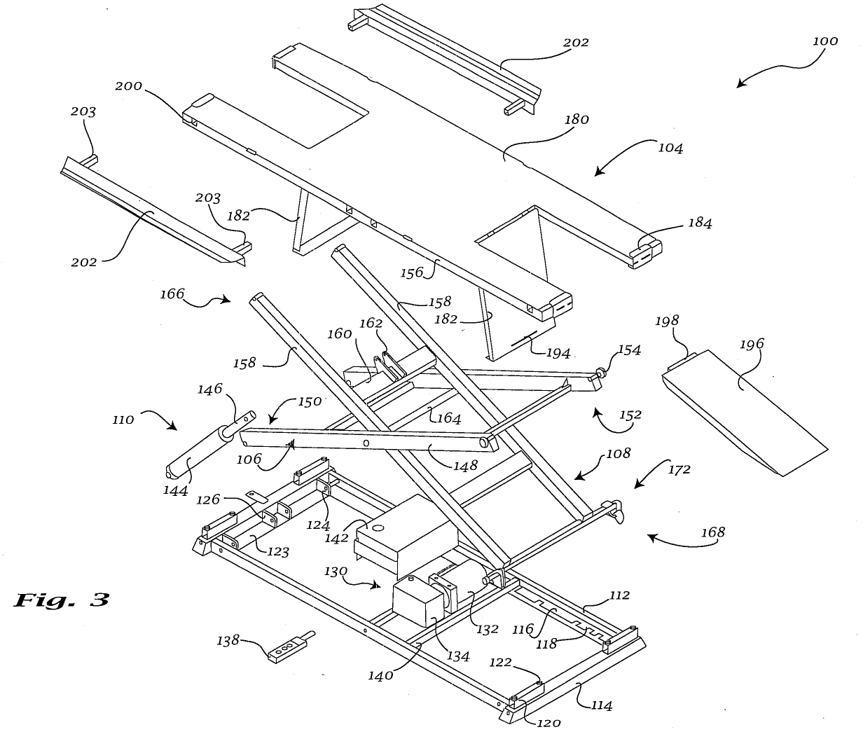

In the exemplary embodiment, second end 152 of first support frame 106 may be slidably coupled to lift platform 104. For example, in one embodiment, second end 152 may include a pair of rollers 154 (shown in FIGS. 2 and 3) coupled thereto that enables second support frame 108 to slide in a substantially lateral direction with respect to lift platform 104. In another embodiment, roller 154 may be slidably coupled within a channel (not shown) that may be defined in a side wall 156 of lift platform 104.

Lift assembly 100 may also include second support frame 108, as shown in FIGS. 1-3. In the exemplary embodiment, second support frame 108 may include a pair of support arms 158 that may be substantially parallel to one another. A stabilizing member 160 may be coupled to each support arm 158 such that stabilizing member 160 may extend between the pair of support arms 158. In one embodiment, stabilizing member 160 may include a pair of flanges 162 that may be coupled to piston 146 of hydraulic cylinder assembly 110. Moreover, a pivot shaft 164 may extend between support arms 158. In one embodiment, pivot shaft 164 may be rotatably coupled to first and second support frames 106 and 108 such that first support frame 106 may rotate with respect to second support frame 108 about pivot shaft 164. Each support arm 158 may have a first end 166 and a second end 168. In one embodiment, first end 166 may be pivotally coupled to lift platform 104 using a pivot pin (not shown). Moreover, second end 168 may include a roller 170 (shown in FIG. 1) coupled thereto that enables support arm 158 to slide in a substantially lateral direction with respect to base frame 102. In another embodiment, roller 170 may be slidably coupled within a channel (not shown) that may be defined in side-rails 112 of base frame 102.

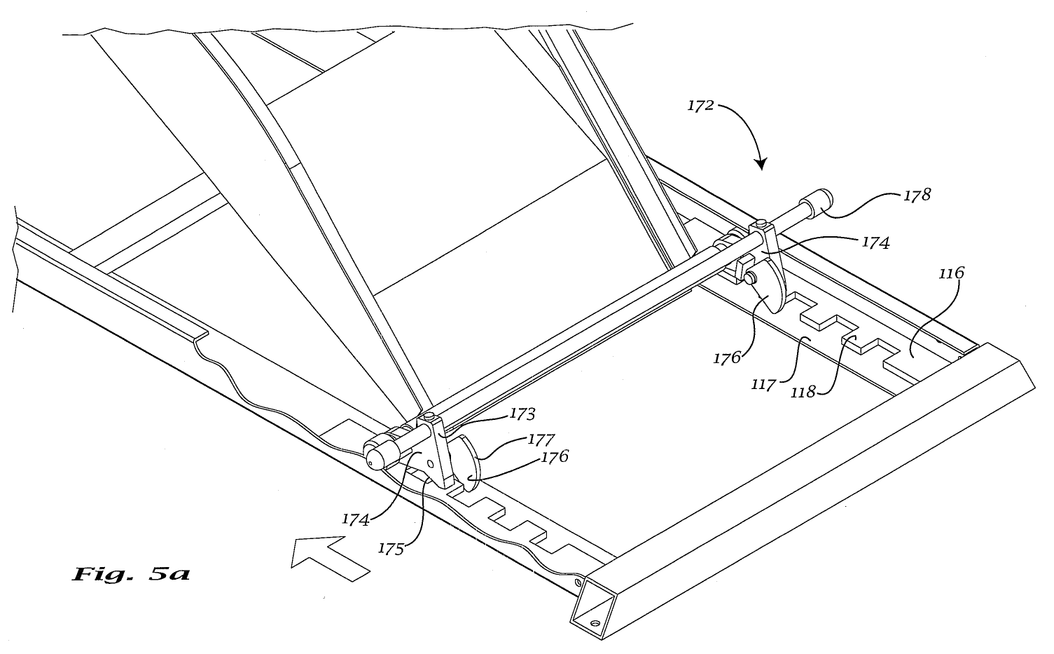

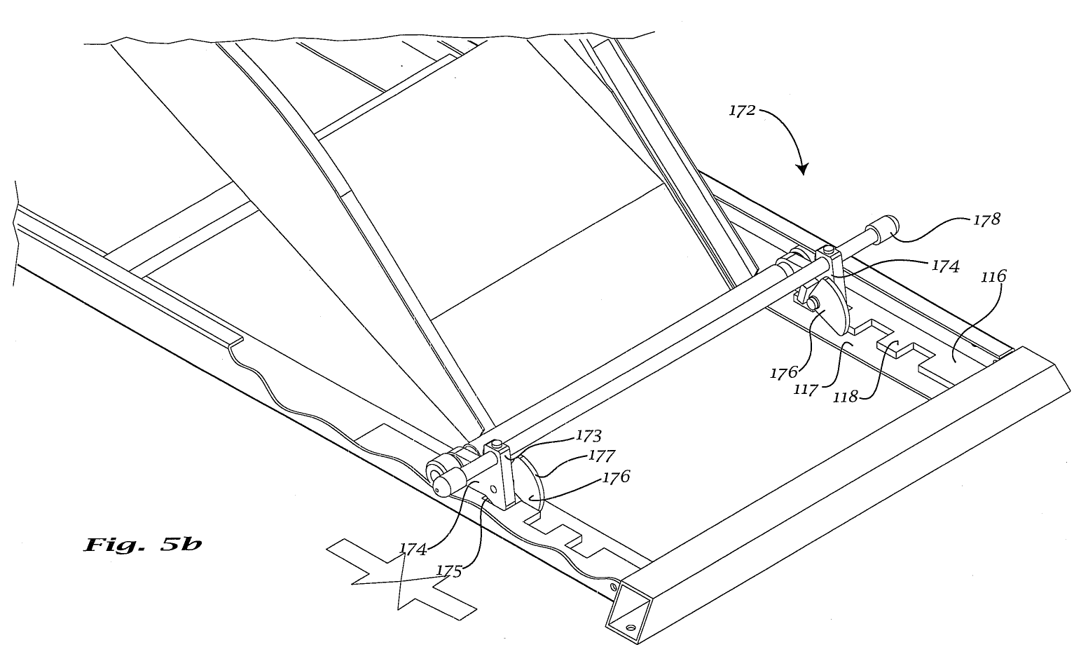

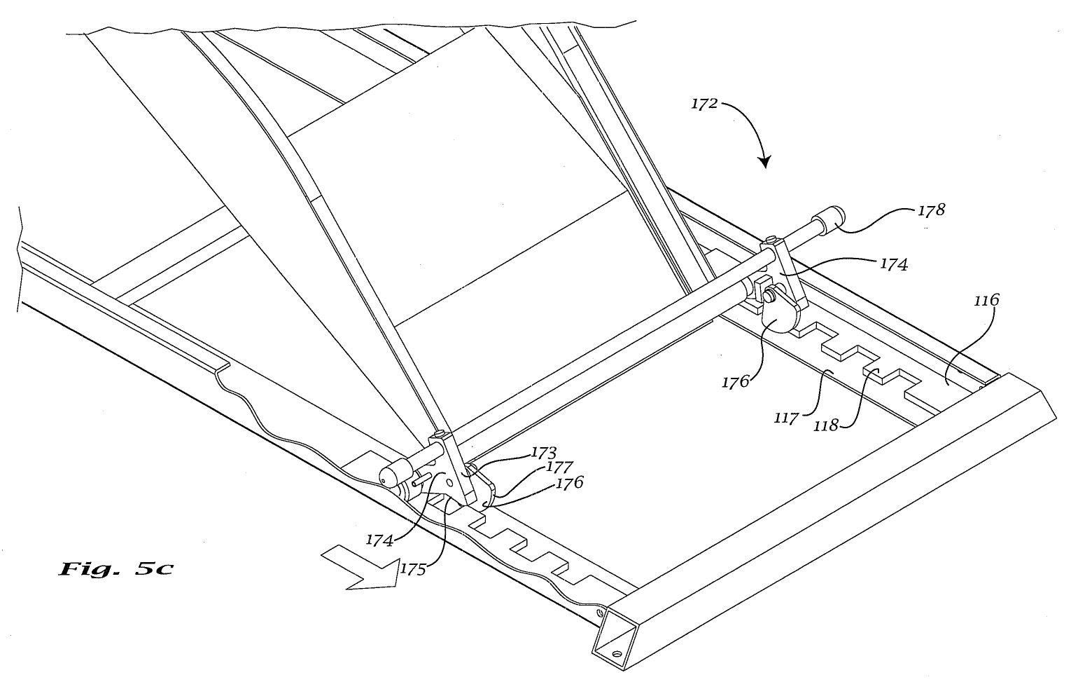

Turning to FIGS. 5a-5c, in one embodiment, a lock assembly 172 may be coupled to second end 168 of each support arm 158 of second support frame 108. Lock assembly 172 may include a pair of locking members 174 that may be pivotally coupled to second end 168. Each locking member 174 may include a bottom face having a section 175 that is substantially angled forward to facilitate sliding locking member 174 over notches 118 during operation and a rear face 173 that is substantially vertical to facilitate engaging locking member 174 with notches 118. Each locking member 174 may include a guiding member 176 that may be pivotally coupled to locking member 174. Each guiding member 176 may have a substantially arcuate face 177 to facilitate raising of lock assembly 172 above elevated portion 116 during operation. Moreover, a lock release shaft 178 may be coupled to each locking member 174 such that lock release shaft 178 may extend between and through the pair of locking members 174 such that at least a portion of lock release shaft 178 may extend away from each locking member 174 and more specifically away from base frame 102.

During operation (shown in FIG. 5a), locking members 174 may slide along elevated portion 116. In the event locking member 174 slides over a notch 118, locking member 174 may pivot about second end 168 such that locking members 174 may be positioned within the notch 118. In such an example, locking members 174 may facilitate preventing lift assembly 100 from collapsing from the expanded position to the loading position (shown in FIG. 5b). In the event there is a failure of hydraulic cylinder assembly 110 which causes lift assembly 100 to collapse, locking members 174 may engage notch 118 of elevated portion 116, which facilitates preventing lift assembly 100 from completely collapsing to the loading position.

In the exemplary embodiment, lift platform 104 may have a top deck portion 180 (shown in FIGS. 2 and 3) that may facilitate supporting a variety of objects thereon. In one embodiment, the object may be, but not limited to, a motorcycle, an all-terrain vehicle and/or any other object that the user desires to lift. Lift platform 104 may also include a pair of drop plates 182 that may be hingedly coupled thereto and may be positioned substantially near each end of lift platform 104. In one embodiment, drop plates 182 may swing from a locked position (as described in more detail below) to a hanging position. The hanging position facilitates providing the user with easier access to various components of the object position on lift platform 104. In the exemplary embodiment, lift platform 104 may also include a pair of locking slide latches 184 that may be slidably coupled at the ends to facilitate locking and unlocking drop plates 182 with respect to lift platform 104. Each locking slide latch 184 may include an elongated slot 186 and a notch 188 defined therein, as shown in FIG. 1. In one embodiment, a fastener 190, such as but not limited to a bolt, may be coupled to lift platform 104 and may extend substantially through elongated slot 186. As a result, locking slide latch 184 may be slidably coupled to lift platform 104.

Each drop plate 182 may include a locking fastener 192 coupled to an end of drop plate 182, wherein locking fastener 192 may extend away therefrom. In one embodiment, locking fastener 192 may be, but not limited to, a bolt. Moreover, at least one drop plate 182 may include an elongated aperture 194 (shown in FIG. 3) defined therein and positioned near the end of drop plate 182. Elongated aperture 194 facilitates coupling a ramp 196, as shown in FIG. 3, to drop plate 182. Specifically, in the exemplary embodiment, ramp 196 may have a flange 198 coupled thereto. In one embodiment, flange 198 may be inserted into elongated aperture 194 to facilitate coupling ramp 196 to lift platform 104.

During operation, drop plate 182 may hang from lift platform 104 in an unlocked position. The user may pivot drop plate 182 about the hinge (not shown) to the locked position, as shown in FIGS. 1 and 2, such that a top surface of drop plate 182 may be substantially co-planar, or flush, with top deck portion 180 of lift platform 104. Once drop plate 182 is in the locked position, the user may slide locking slide latch 184 along the end such that notch 188 may engage locking fastener 192, wherein locking fastener 192 may be position substantially within notch 188 which facilitates locking drop plate 182 in the locked position.

Lift platform 104 may also include a plurality of attachment apertures 200 defined on the sidewalls 156 of lift platform 104. Attachment apertures 200 may enable the user to couple a variety of attachments to lift platform 104. In one embodiment, attachments may be, but not limited to, a tool holder 202 (shown in FIG. 3). Tool holder 202 may include inserts 203 to facilitate coupling tool holder 202 to lift platform 104 via attachment apertures 200 in a mortise-and-tenon arrangement. In another embodiment, tool holder 202 may be coupled to lift platform 104 via a tongue-and-groove arrangement, or any other method known to a person having ordinary skill in the art.

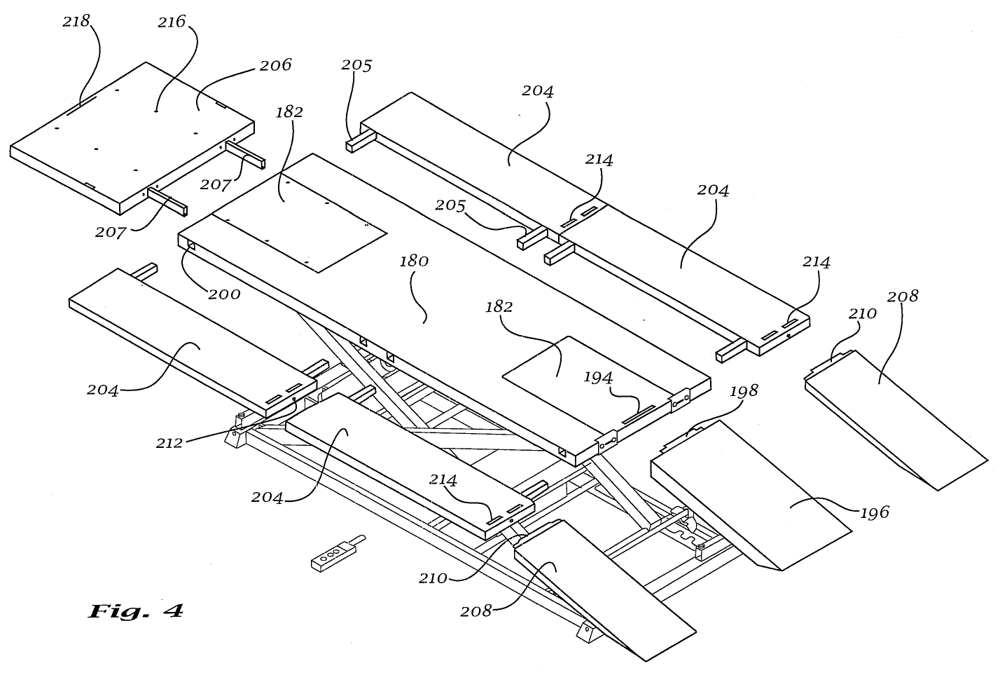

In another embodiment (shown in FIG. 4), the attachments may be a set of side platform extenders 204 and front platform extender 206 that facilitate expanding the top surface area of top deck portion 180 to enable the user to load larger objects thereon. Each of side platform extenders 204 may include inserts 205 to facilitate coupling side platform extenders 204 to lift platform 104 via attachment apertures 200 in a mortise-and-tenon arrangement. In another embodiment, side platform extenders 204 may be coupled to lift platform 104 via a tongue-and-groove arrangement, or any other method known to a person having ordinary skill in the art. Side platform extenders 204 may include apertures 212 defined therein for removably coupling side platform extenders 204 to each other by means of screws, bolts, or other similar methods known in the art. Side platform extenders 204 may also include elongated apertures 214 defined therein and positioned substantially near an end of each side platform extender 204. In one embodiment, elongated apertures 214 facilitate coupling a side ramp 208 to side platform extender 204. Specifically, in the exemplary embodiment, side ramps 208 may have a flange 210 coupled thereto and extending substantially away from each side ramp 208. In one embodiment, flanges 210 may be inserted into elongated apertures 212 to facilitate coupling side ramps 208 to side platform extenders 204.

Front platform extender 206 may include inserts 207 to facilitate coupling front platform extender 206 to lift platform 104 via attachment apertures (not shown) in a mortise-and-tenon arrangement. In another embodiment, front platform extender 206 may be coupled to lift platform 104 via a tongue-and-groove arrangement, or any other method known to a person having ordinary skill in the art. Front platform extender 206 may include apertures 216 defined therein which may facilitate the coupling of a utility apparatus (not shown) thereto. In one embodiment, the utility apparatus may be a wheel chock or other wheel or vehicle securing apparatus. Moreover, front platform extender 206 may include an elongated aperture 218 defined therein and positioned substantially near an end of front platform extender 206. In one embodiment, elongated aperture 218 facilitates coupling ramp 196 to front platform extender 206, as described above.

During operation of lift assembly 100, the user may position lift assembly 100 in any part of a workspace (not shown). Next, the user may collapse lift assembly into the loading position. Once lift assembly 100 is in the loading position, lift platform 104 may be positioned adjacent base frame 102 such that lift platform 104 may be in contact with foot stops 120. Ramp 196 may be coupled to drop plate 182 to enable the user to roll an object on to lift assembly 100. Once the object is positioned on lift platform 104 and secured thereto, the user may operate remote control 138 to facilitate actuating hydraulic cylinder assembly 110. Upon actuation of the hydraulic cylinder assembly 110, piston 146 may extend away from barrel 144. As a result, an amount of force is applied to second support frame 108. The force causes second support frame 108 to rotate about pivot shaft 164 with respect to first support frame 106. As a result, second end 152 of first support frame 106 may slide substantially laterally towards a middle portion of platform 104 while second end 168 of second support frame 108 may slide substantially laterally towards the middle portion of base frame 102. As such, the height of the lift platform 104 with respect to the base frame 102 may be increased.

Referring to FIG. 5c, in the event a user desires to collapse lift assembly 100 from the expanded position to the loading position, the user may disengage lock assembly 172. Specifically, the user may pivot lock assembly 172 about second end 168 such that locking members 174 may be substantially disengaged from notch 118. In one embodiment, the user may pivot lock assembly 172 about second end 168 such that lock release shaft 178 may come in contact with support arms 158 which facilitates positioning locking members 174 away from notches 118. As a result, guiding members 176 may lower below elevated portion 116 such that substantially arcuate face 177 is slidably engaged with base portion 117, thereby elevating locking members 174 above elevated portion 116. Consequently, support arms 158 may slide in a substantially lateral direction along elevated portion 116 of base frame 102 without the locking members 174 substantially engaging notches 118. The user may then operate remote control 138 to facilitate retracting piston 146 with respect to barrel 144. As a result, second end 152 of first support frame 106 may slide substantially laterally towards the end of platform 104 while second end 168 of second support frame 108 may slide substantially laterally towards the end of base frame 102. As such, the height of lift platform 104 with respect to base frame 102 may be substantially decreased.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A lifting apparatus comprising:
a base frame;
a platform;
a first support frame comprising a plurality of support arms, said first support frame extends between said base frame and said platform;
a second support frame comprising a plurality of support arms, said second support frame extends between said base frame and said platform, said second support frame is rotatably coupled to said first support frame;
a lifting power source assembly coupled to said base frame and said second support frame; and
a pump coupled to said base frame, said pump is coupled in flow communication to said lifting power source assembly using a fluid line.

2. A lifting apparatus in accordance with claim 1 wherein said first support frame is pivotally coupled to said base frame and slidably coupled to said platform.

3. A lifting apparatus in accordance with claim 1 wherein said second support frame is slidably coupled to said base frame and pivotally coupled to said platform.

4. A lifting apparatus in accordance with claim 1 wherein said pump further comprises:
a fluid tank; and
a motor operatively coupled to said fluid tank and said fluid line.

5. A lifting apparatus in accordance with claim 1 wherein said pump is coupled to said base frame using a pair of mounting members such that said pump is positioned substantially between a pair of side-rails of said base frame.

6. A lifting apparatus in accordance with claim 5 further comprising a cover portion coupled to said pair of mounting members such that said pump is coupled within said cover portion, which facilitates preventing damage to said pump.

7. A lifting apparatus in accordance with claim 1 further comprising a plurality of notches defined in at least one side-rail of said base frame.

8. A lifting apparatus in accordance with claim 7 further comprising a locking assembly coupled to said second support frame, said locking assembly facilitates engaging said notches to enable locking said lifting apparatus in a specific position.

9. A lifting apparatus in accordance with claim 7 further comprising a locking assembly rotatably coupled to said second support frame, wherein said locking assembly comprises a locking member that facilitates engaging one of said notches when said locking assembly is in a locking position.

10. A lifting apparatus in accordance with claim 9, wherein said locking assembly further comprises a lock release shaft that facilitates disengaging said locking member from one of said notches.

11. A lifting apparatus in accordance with claim 9, wherein said locking assembly further comprises a guiding member rotatably coupled to said locking member, wherein said guiding member facilitates raising said locking assembly above said notches.

12. A lifting apparatus in accordance with claim 1, wherein said lifting power source assembly further comprises:
a hydraulic cylinder; and
a piston slidably coupled to said hydraulic cylinder.

13. A lifting apparatus in accordance with claim 1 further comprising a plurality of drop plates hingedly coupled to said platform.

14. A lifting apparatus in accordance with claim 13 wherein each drop plate is releasably coupled to said platform via at least one latch such that each drop plate is substantially flush with said platform.

15. A lifting apparatus in accordance with claim 13 further comprising at least one ramp removably coupled to at least one of said drop plates.

16. A lifting apparatus in accordance with claim 1 further comprising a remote control device operatively coupled to said pump, said remote control device facilitates controlling said lifting power source assembly.

17. A lifting apparatus in accordance with claim 1 further comprising at least one platform extender removably coupled to said platform.

18. A lifting apparatus in accordance with claim 17 further comprising a plurality of attachment apertures defined in at least one side wall of said platform, wherein said platform extender is removably coupled to said platform via said attachment apertures.

19. A lifting apparatus in accordance with claim 17 further comprising at least one ramp removably coupled to said at least one platform extender.

20. A method of lifting an object, said method comprises:
loading an object onto a platform supported by a first support frame, a second support frame and a base frame, wherein the first and second support frames are rotatably coupled together using a pivot shaft;
actuating a pump that is coupled in fluid communication with a hydraulic cylinder;
extending a piston that is slidably coupled to the hydraulic cylinder; and
increasing a height of the platform by rotating the second support frame about the pivot shaft with respect to the first support frame.

21. A method in accordance with claim 20, wherein said loading an object onto a platform further comprises:
coupling a ramp to a drop plate, wherein the drop plate is hingedly coupled to the platform; and
rolling the object onto the platform using the ramp.

22. A method in accordance with claim 21 further comprising:
locking at least one of the first and second support frames to the base frame to facilitate preventing lateral movement of the first and second support frames, wherein said locking at least one of the first and second support frames further comprises:
rotating a locking assembly about an end of at least one of the first and second support frames; and
engaging at least a portion of the locking member with a notch defined on the base frame.

23. A method in accordance with claim 22 further comprising lowering the platform, wherein said step of lowering the platform further comprises:
rotating the locking assembly about the end of at least one of the first and second support frames to facilitate disengaging the locking member from the notch;
lowering a guide member to facilitate raising the locking assembly above the notch; and
controlling the lifting power source assembly such that the piston retracts with respect to the hydraulic cylinder to facilitate reducing the height of the platform.

24. A method in accordance with claim 21 further comprising:
sliding a locking slide latch to facilitate unlocking the at least one drop plate with respect to the platform, wherein the locking slide latch is slidably coupled to the platform and the at least one drop plate; and
rotating the at least one drop plate about a hinge, wherein the unlocked drop plate facilitates providing increased access to the object positioned on the platform.

25. A method in accordance with claim 20, wherein said loading an object onto a platform further comprises:
coupling at least one platform extender to the platform;
coupling a ramp to the platform extender; and
rolling the object onto the platform using the ramp.
